(19) United States
(12) Patent Application Publication
(10) Pub. No.: US 2005/0151849 A1
(43) Pub. Date: Jul. 14, 2005

(54) Method and system for image driven clock synchronization

(76) Inventors: Andrew Fitzhugh, Menlo Park, CA (US); Richard Carl Gossweiler, Santa Clara, CA (US); Patrick Goddi, San Jose, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/757,831

(22) Filed: Jan. 13, 2004

(51) Int. Cl. H04N 5/225

(52) U.S. Cl. 348/207.99

(57) ABSTRACT

A method and system of synchronizing a clock in an electronic device having image capture capabilities includes receiving an image of a time keeping device from the electronic device with image capture capabilities, determining a current time using image analysis operations on the image of the time keeping device and setting the current time on a clock associated with the electronic device with image capture capabilities.

### BACKGROUND OF THE INVENTION

The present invention relates to an interface for electronic devices. Many electronic devices include a clock to display time and identify the content they are recording, playing or managing. In a camera or video device, time provides a mechanism for identifying the photos or video as they are taken. Time information provides both a basic and yet important type of metadata as it allows the content to be connected temporally with other events or other devices performing similar functions. For example, an accurate time stamp associated with photos and video taken at a live concert can be used to associate the photos and/or video with music separately recorded using a different electronic recording device. Many other types of associations between content and functionality are possible when the time on different devices is set accurately and reliably.

Currently, time is typically set on electronic devices manually by operating a series of menus, buttons, scroll selections and other user interface controls built into the particular electronic device. These user interface controls rely on the user to both obtain the time and then input the time into the device through the user interface controls. The user often enters the time upon initial use of the electronic device as the manuals are available and the user has set aside time to configure the device. Assuming the user obtains the correct time and makes no operational errors, the initial photos, video or other data obtained with these various electronic devices are most likely to include the correct time.

Subsequent use of the camera, video and other electronic device is much less likely to have the correct time or, in some cases, any time at all. Depending on the frequency of use, the batteries in the electronic device may lose charge between uses and therefore lose correct time settings or revert to a series of dashes or no time values. Time can also be inaccurate due to change in time zones, adjustments in time due to daylight savings time or replacement of one or more batteries.

Despite these events, users frequently start using the electronic device without resetting the time. In some cases, the user has forgotten how to access and set the time in the electronic device as the user interface for setting time is buried in portions of the user interface that are difficult to access or use. In other cases, the user is too busy to engage in the tedious process of operating the various menus, buttons, scroll selections and other user interface controls to properly set the time. For example, setting the time in a camera for a candid photo or during an emergency event may become secondary to capturing the image or video of the event as it occurs.

For at least the reasons described above, the time setting in a camera, video or other electronic device cannot be relied upon as an accurate reference point or as metadata for higher level applications. The burden of using the conventional user interface on cameras and electronic devices is sufficiently high so as to dissuade a majority of users from diligently keeping the time information up-to-date and accurate. Consequently, setting the time on these electronic devices has become an afterthought for most users. This is true even though the user may later find the time information to be as important a piece of information as the underlying images or other data collected.

### BRIEF DESCRIPTION OF THE DRAWINGS

FIG. 1 is a block diagram schematic of a system containing various electronic devices synchronizing to time keeping devices in accordance with one implementation of the present invention;

FIG. 2 is a flowchart diagram illustrating the operations for synchronizing a timer on an electronic device using image processing and implementations of the present invention;

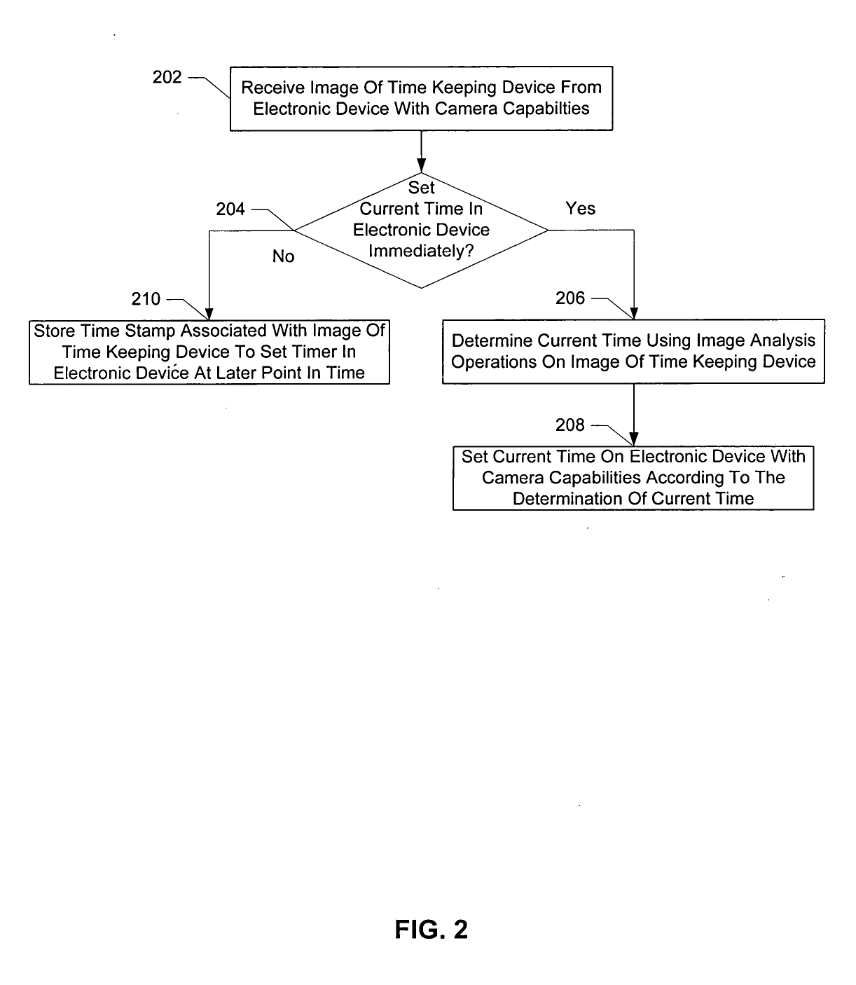

FIG. 3 is a flowchart diagram of the operations to determine the current time from the image of a time keeping device in accordance with one implementation of the present invention;

FIG. 4 is a system diagram including numerous different devices setting time in accordance with various implementations of the present invention; and

FIG. 5 is a block diagram of a system used in one implementation for performing the apparatus or methods of the present invention.

Like reference numbers and designations in the various drawings indicate like elements.

### SUMMARY OF THE INVENTION

One aspect of the present invention features a method of synchronizing a clock in an electronic device having image capture capabilities. The synchronizing of the clock in the electronic device includes receiving an image of a time keeping device from the electronic device with image capture capabilities, determining a current time using image analysis operations on the image of the time keeping device and setting the current time on a clock associated with the electronic device with image capture capabilities.

### DETAILED DESCRIPTION

Aspects of the present invention are advantageous in at least one or more of the following ways. An electronic device can rely upon clocks or other time keeping devices to accurately set a timer. The time displayed on a clock is photographed, analyzed and used to set the time in the electronic device directly. This allows multiple devices in a venue to synchronize their internal clocks to a single time base. This avoids inaccuracies due to users misreading the time or relying on different clocks or time keeping mechanisms.

Implementations of the present invention are also advantageous as they simplify the setting of time on various electronic devices. Instead of operating the conventional tedious user interface, a user need only obtain an image of a clock, watch or other source of time to set the time. The electronic device automatically performs image processing routines on the displayed time information and then sets the device appropriately. In a camera device, the user can take a picture of a clock or watch and then select to reset the time according to the time displayed in the resulting image.

Synchronizing multiple electronic devices over a network is yet another advantage of the present invention. In a ubiquitous computing environment, an image of a clock or other device can be quickly propagated to a variety of different electronic device and used to synchronize time on the various devices. At a minimum, one device could take a photo of a clock or other time keeping device and then propagate the image to multiple non-image gathering devices on a local, personal or even wide area network. Devices broadcasting the photo to other devices using Bluetooth and IEEE 802.11 wireless protocols, various LAN wired protocols and other high speed protocols could effectuate a scalable synchronization of electronic devices. This would have the effect of ensuring synchronization between a variety of homogeneous and heterogeneous devices and allow for higher level applications to more readily rely upon the timer data.

Yet another advantage of the present invention includes using time information from a variety of sources. In addition to images of an actual clock, the present invention would also work with manually written or sketched images of clocks as well as synthetically created images of clocks. For example, a person could sketch the face of a clock and date information on a paper and then set the time by taking a photo of the sketched image of the clock and date. In another example, a computer with date and time information could synthetically generate an image of an analog clock including the current day and date and then send this synthetically created image to synchronize devices around the network in accordance with the present invention. This would bypass the need for having a camera take an image of an actual clock.

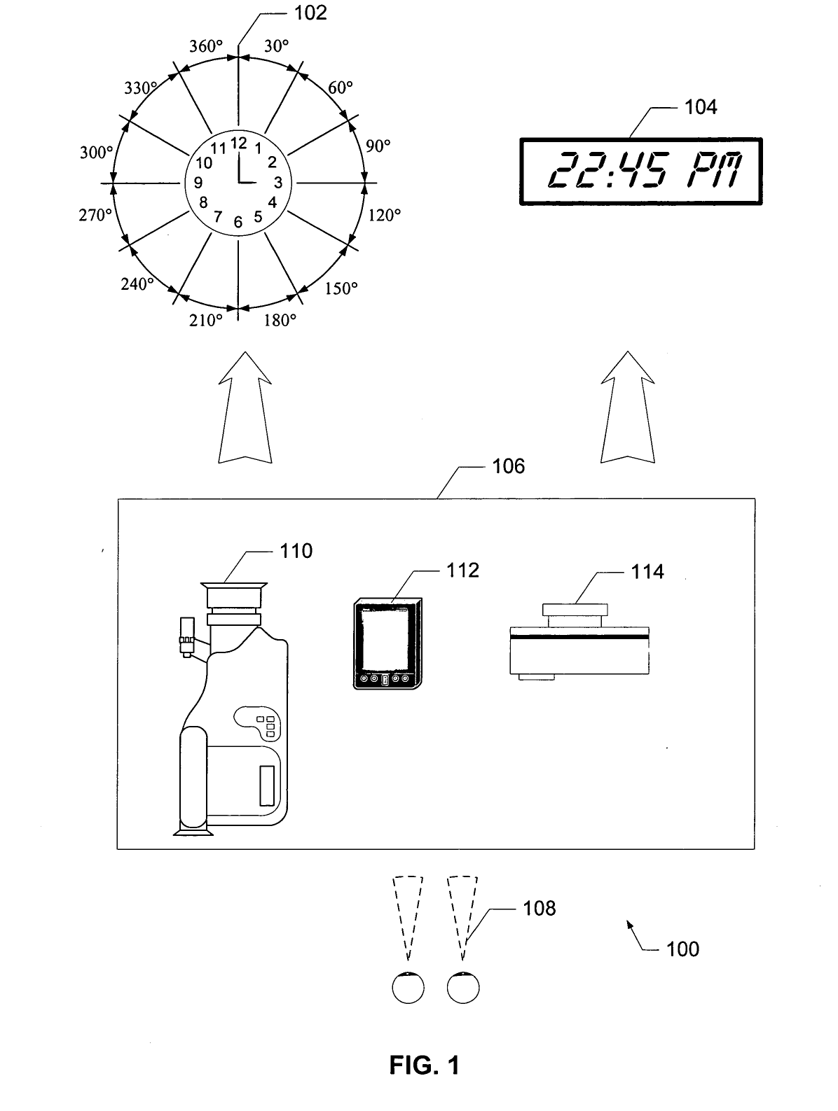

FIG. 1 is a block diagram schematic of a system 100 containing various electronic devices synchronizing to time keeping devices in accordance with implementations of the present invention. As illustrated, system 100 includes an analog format clock 102, a digital format clock 104, electronic devices 106 and viewing eyes 108. In this example, electronic devices 106 includes a digital video device 110, a personal digital assistant (PDA) 112 and a digital camera 114 each having image capture capabilities through either an integrated camera or a remotely accessible camera device connected to the electronic device over a network. For example, PDA 112 may lack an integrated camera yet may obtain digital images in real-time or near real-time from either digital video device 110 or digital camera 114 through a network incorporating Bluetooth, Infra-red or other wireless technologies. While lacking the integrated camera, PDA 112 may alternatively be wired directly to digital video device 110, digital camera 114 or any other digital device capable of capturing images.

Analog format clock 102 illustrated in FIG. 1 illustrates the radial or angular measurements around the clock and the relationship to the hands and the clock dial. In this example, each numeric value on the dial of the clock is separated by one or more 30 degree increments. Time can be determined on analog format clock 102 by measuring the angular difference between the hour, minute and second hand relative to their rotational position on the clock face. On digital format clock 104, time is determined more directly by determining the numeric values in each segment of digital format clock 104. If available as illustrated, a time-of-day indicator specifying either “AM” or “PM” is also generally indicated directly on the face of digital format clock 104 in addition to the time.

In either example, viewing eyes 108 are used to aim at least one of electronic devices 106 towards the time keeping devices to obtain an image of either analog format clock 102 or digital format clock 104 as illustrated. If an electronic device 106 has a camera then viewing eyes 108 may either peer through the viewfinder of the camera integrated with the electronic device or merely aim the camera in the general vicinity of the time keeping device. The image of the time keeping device is then used to synchronize or set the timer on the one or more electronic devices 106 in accordance with implementations of the present invention.

FIG .2 is a flowchart diagram illustrating the operations for synchronizing a timer on an electronic device using image processing and implementations of the present invention. The synchronizing operation begins upon receipt of an image of time keeping device from electronic device with camera capabilities (202). A user can take the photo using camera integrated with the electronic device or receive an image from a camera remotely located to the camera. Either implementation allows the electronic device with camera capabilities to receive an image for use in setting the time in accordance with the present invention.

Next, the synchronizing operations determine if the current time is to be set in the electronic device immediately or at a later point in time (204). Setting the current time on the electronic device immediately includes determining the current time from the image. Rather than rely on the user or operator to determine the time, the synchronization operation determines the current time using image analysis operations on the image of the time keeping device (206). These operations for determining the current time depend on whether the time keeping device uses either an analog clock format or a digital clock format; both are described in further detail later herein.

Once the current time is determined, the synchronization operation sets the current time on the electronic device being configured or setup (208). In one implementation, a software application running on a microprocessor in the electronic devices calls upon an application programming interface (API) to set a timer to the current time as determined. Additionally, the software also uses the API to obtain time-of-day information to initialize the timer in the electronic device to either an “AM” or “PM” setting as appropriate. By setting the current time on the electronic device contemporaneous with taking the image, the current time derived from the image of the time keeping device (i.e., clock or wristwatch) is up-to-date and accurate. In alternate implementations, synchronizing the timer on the electronic device can be achieved directly through firmware built into the hardware of the electronic device rather than using software and the API to configure the timer.

Alternatively, another implementation of the present invention can defer setting the timer in the electronic device until a later time. Instead of setting the current time on the electronic device immediately as described above, this process is deferred. At first, timing of photos and other content is measured relative to the time stamp associated with the image of time keeping device (210). Later, the current time is derived from the image of the time keeping device as described later herein, the times of the images are adjusted and the timer on the electronic device is set in accordance with the present invention.

Deferring image recognition and synchronization to a later time opens up the possibility of implementing the clock setting functions in many different ways. For example, a user interface can display the photo of the clock at a later point in time and then prompt the user to operate controls on the device to set the time of the electronic device. By setting the time on the electronic device, the user also has the option of updating the time stamp information corresponding to photos or other content taken subsequent to the photo of the clock. This reduces and simplifies the image processing requirements associated with the clock setting functions as image recognition of either the analog or digital clock is not required. Instead, implementations of the present invention rely upon the users ability to quickly read the time and determine the time setting in a photo. Timing information recorded in the photos or other content is then updated in accordance with the original time stamp of the content and timing information stored along with each photo or other content. Thus the users ability to “tell time” is leveraged in the recognition process while the user gains the benefit of being able to recover an accurate and useful timestamp at a subsequent time and place convenient to the user.

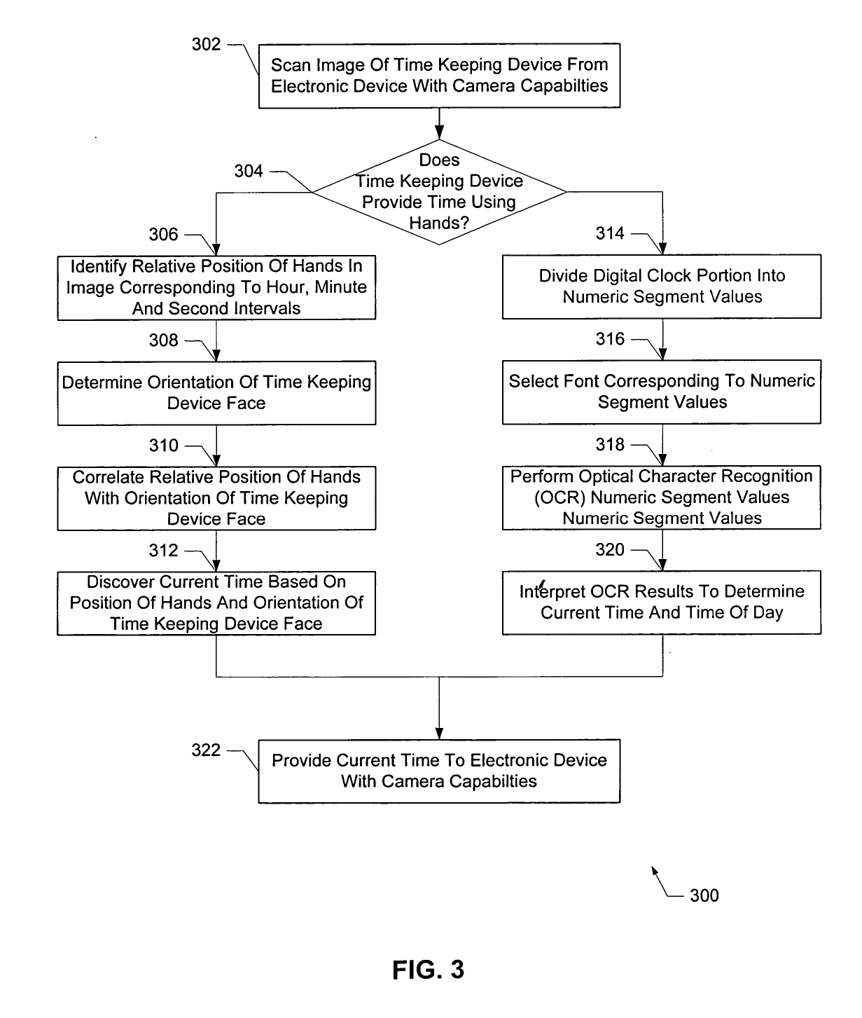

FIG. 3 is a flowchart diagram of the operations to determine the current time from the image of a time keeping device in accordance with one implementation of the present invention. The operation begins by scanning the image of the time keeping device obtained from the electronic device with camera capabilities (302). As previously described, the images being scanned can be obtained from either an electronic device having an integrated camera for taking the images or transmitted from other electronic devices on the network with similar capabilities. In one implementation, this time keeping device is an actual physical clock or watch that automatically changes time, day and date information over time. Alternatively, the time keeping device could also be a manually drawn picture of an analog or digital clock with time, day and date information. For example, a person could draw a picture of a clock including day and date information on a piece of paper and then use the paper with the clock image and date information for the image of the time keeping device.

In yet another implementation, the image of the clock can actually be created synthetically from a computer or other electronic device already considered to have accurate time and date settings. In this latter approach, the electronic device with camera capabilities does not actually have a camera but instead has the ability to synthesize the image of a clock set to the current time, day and date information. For example, a computer could synthetically create a clock indicating 3:00 by placing a circle around a longer and shorter radius extending from the center of the circle to the edge of the circle at the 0 degree and 90 degree position.

The current time determination operation first checks if the time keeping device in the scanned image uses “hands” on the dial of a clock or watch to display time (304). In one implementation these “hands:” include an hour hand, a minute and a second hand as used on conventional analog clocks. If hands are used to display the time, the current time analysis further identifies a relative position of the hands in the image corresponding to the hour, minute and second interval hands (306). In one implementation, the relative location of the hands on the clock dial is determined by measuring angles between the various hands; angles between the hands may range from 0 to 360 degrees. Image processing operations used to identify the hands may include contrast measurements over the dial of the clock dial or the use of filters that identify the shape of the hands compared with the underlying clock face dial.

While hours, minutes and seconds can be used to describe the current time, alternate implementations may rely only upon only hours or minutes or seconds along with any combination thereof depending on the particular requirements or preference. In some cases, it may not be important to set the seconds or minutes if one is correcting for a much larger measure of time encompassed by time zones.

Next, the time determination operation determines the orientation of the dial on the time keeping device to determine the actual time (308). Each character on the dial of the clock or watch is compared with one or more possible characters typically found on the clock or watch dial. For example, numerals 1 through 12 are compared with the various characters found on the clock or watch dial being scanned using various font sizes and typeface. In one implementation, an ordered list of fonts most likely used on clock or watch dials can be referenced during this comparison operation to improve the speed and accuracy of this orientation operation.

The current time determination operation then uses the orientation information to draw a correlation between the relative position of the hands and the orientation of time keeping device dial (310). This essentially indicates the position of the hands and the numerals on the face of the clock or watch dial the hands are pointing towards. By way of a look-up-table or other similar reference, the current time discovery depends upon the position of the hands and orientation of the dial of the time keeping device. For example, a look-up-table may indicate that the hour hand over the numeral “6” and the minute hand over the number “12” correspond to a current time of “6:00” or “18:00”. Once discovered, the current time is used to set the one or more timers in the various electronic devices.

If “hands” are not being used to display the time in the image (304), the current time analysis is instead based upon the format of a digital clock. In one implementation, the digital clock portion is divided into numeric segment values to assist in the further processing (314). Next, the current time analysis selects a font most likely to correspond to the numeric values (316). As previously described, an ordered list of fonts can be used to improve the speed and accuracy of identifying the numeric values from the digital clock image. In addition, a font can be selected based upon the popularity of the font as well as the common use of the font in association with digital clock and watch displays.

Selecting the proper font assists in performing optical character reading (OCR) on the digital clock format and the numeric segment values (318). The results of the OCR are then interpreted to determine the current time and, optionally, the time-of-day (320). In either the analog clock format or digital clock format, the results of the current time analysis are provided to the requesting electronic device in accordance with the present invention.

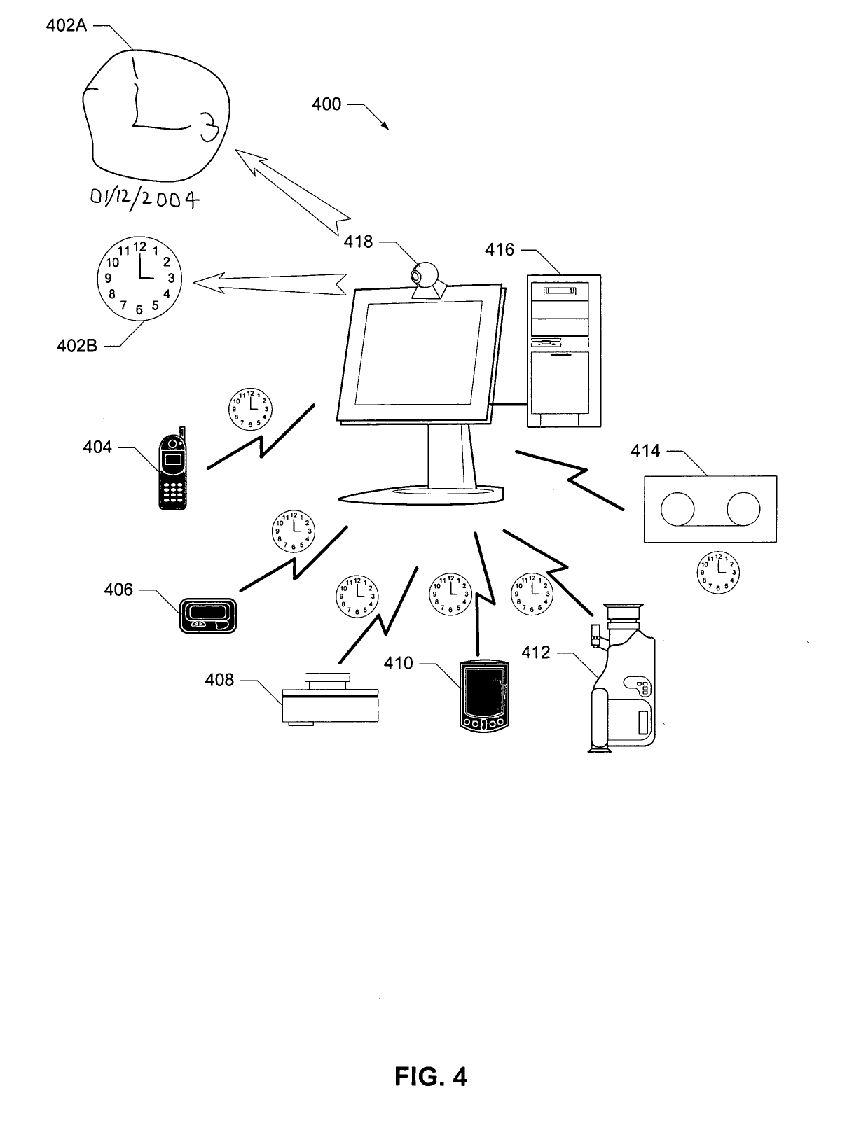

FIG. 4 is a system diagram including numerous different devices setting time in accordance with various implementations of the present invention. This example system 400 includes clocks 402A and 402B, a phone 404, a palmtop 406, a digital camera 408, a PDA 410, a video camera 412, a video cassette recorder (VCR) 414 and a computer 416 with personal video cam (PVC) 418 mounted onto the display of computer 416. Many other consumer and other devices using time information could be included but have been omitted for brevity.

In this arrangement, the image of a time keeping device can be obtained in several ways. PVC 418 or digital camera 408 can take a photograph of a clock 402A containing mechanical or electromechanical parts and a face for displaying the time. Alternatively, the same PVC 418 or digital camera 408 can take a photograph of clock 402B generated by a person sketching an image of the clock and optionally date information as illustrated. In yet another alternative, computer 416 uses an internal clock and calendar to generate an image of a clock and the date synthetically instead of using a camera. Computer 416 provides this synthetic image to other devices on the network requesting time information.

In effect, the image of the clock becomes the protocol for setting time and date information in accordance with implementations of the present invention. Accordingly, devices without cameras including phone 404, palmtop 406, PDA 410 and VCR 414 obtain the image of a clock generated as previously described over the network. For example, these devices can communicate over the network using either wired or wireless connections and protocols including TCPIP, 802.11, Bluetooth, Ethernet as well as many other packet or connection-oriented protocols.

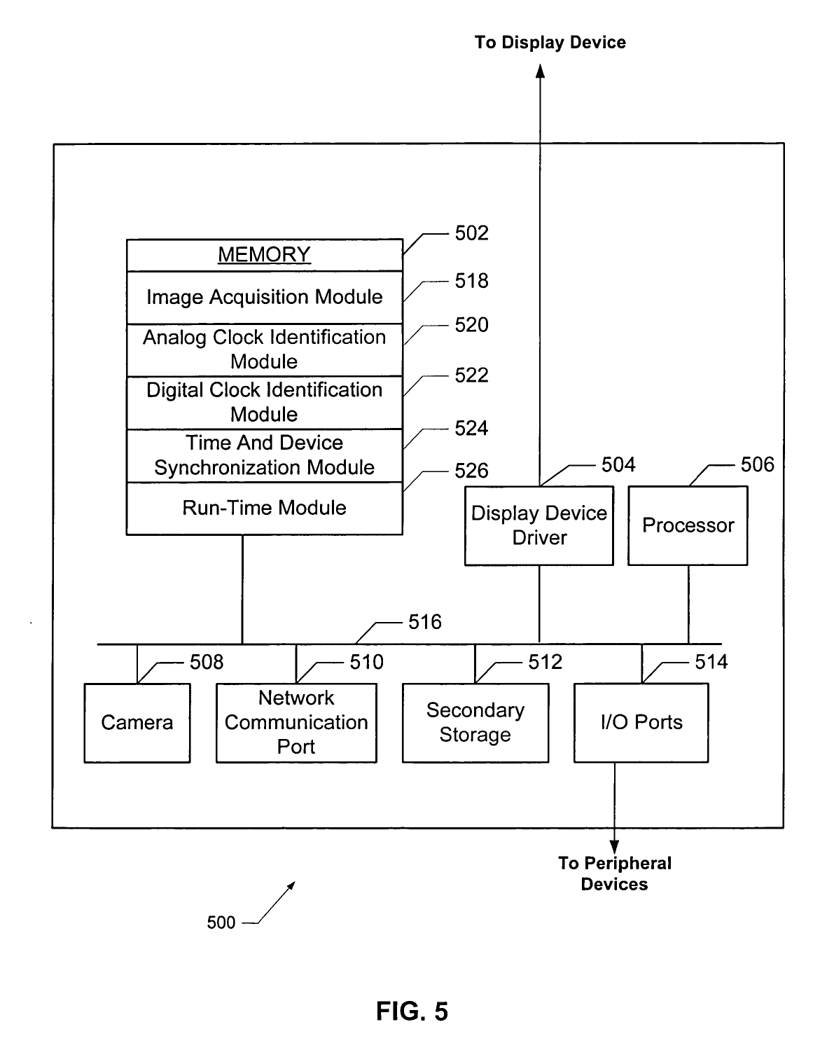

FIG. 5 is a block diagram of a system 500 used in one implementation for performing the apparatus or methods of the present invention. System 500 includes a memory 502 to hold executing programs (typically random access memory (RAM) or read-only memory (ROM) such as a flash RAM), a display device driver 504 capable of interfacing and driving a display or monitor device, a processor 506, a camera 508 for capturing images of time keeping devices and other images, a network communication port 510 for data communication, a secondary storage 512 with secondary storage controller, and input/output (I/O) ports 514 also with I/O controller operatively coupled together over an interconnect 516. System 400 can be preprogrammed, in ROM, for example, using field-programmable gate array (FPGA) technology or it can be programmed (and reprogrammed) by loading a program from another source (for example, from a floppy disk, a CD-ROM, or another computer). Also, system 500 can be implemented using customized application specific integrated circuits (ASICs).

In one implementation, memory 502 includes an image acquisition module 418, an analog clock identification module 520, a digital clock identification module 422, a time and device synchronization module 524 and a run-time module 526 that manages system resources used when processing one or more of the above components on system.

Image acquisition module 518 acquires an image of a time keeping device through camera 508 or through a network connection from other devices capable of taking images. As previously described, image acquisition module 518 can also “obtain” the image without any camera by generating the image of the time keeping device synthetically based upon time and date information maintained within system 500. In operation, analog clock identification component 520 analyzes the acquired image identifying the position of the hands and orientation of the dial as previously described. This information is used to determine a current time for purposes of setting a timer in a camera, video or other electronic device.

Alternatively, digital clock identification component 522 performs a similar type of analysis but for a digital clock rather than the analog clock or watch having hands and a dial. Instead, digital clock identification component 522 identifies the numeric values in the digital display and optionally a time-of-day (i.e., “AM” or “PM”) in accordance with implementations of the present invention. The current time information is then sent to time and device synchronization module 524 where a timer embedded in the camera, video device or other electronic device is synchronized with the time keeping device image photographed with camera 508 or other image acquisition device on a remotely located electronic device.

While examples and implementations have been described, they should not serve to limit any aspect of the present invention. Accordingly, implementations of the invention can be implemented in digital electronic circuitry, or in computer hardware, firmware, software, or in combinations of them. Apparatus of the invention can be implemented in a computer program product tangibly embodied in a machine-readable storage device for execution by a programmable processor; and method steps of the invention can be performed by a programmable processor executing a program of instructions to perform functions of the invention by operating on input data and generating output. The invention can be implemented advantageously in one or more computer programs that are executable on a programmable system including at least one programmable processor coupled to receive data and instructions from, and to transmit data and instructions to, a data storage system, at least one input device, and at least one output device. Each computer program can be implemented in a high-level procedural or object-oriented programming language, or in assembly or machine language if desired; and in any case, the language can be a compiled or interpreted language. Suitable processors include, by way of example, both general and special purpose microprocessors. Generally, a processor will receive instructions and data from a read-only memory and/or a random access memory. Generally, a computer will include one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM disks. Any of the foregoing can be supplemented by, or incorporated in, ASICs.

While specific embodiments have been described herein for purposes of illustration, various modifications may be made without departing from the spirit and scope of the invention. For example, implementations of the present invention are describes as working with either an analog clock format or digital format time keeping device however, the present invention could also be applied to a time keeping device that provides both an analog clock format and digital clock format for time. Accordingly, one alternate implementation of the present invention could be adapted to work with a clock that displays hours, minutes and seconds in an analog clock format while simultaneously displaying time-of-day and date using a digital clock format. Yet another implementation could be adapted to also recognize and set the month, date and year on an electronic device keyed off of the month, date and/or year displayed on the time keeping device. Instead of only processing time and/or time-of-day information, implementations of the present invention could be adapted to additionally recognize each of the months, days and years displayed on a time keeping device. Accordingly, the invention is not limited to the above-described implementations, but instead is defined by the appended claims in light of their full scope of equivalents.

1. A method of synchronizing a clock in an electronic device having image capture capabilities, comprising:
receiving an image of a time keeping device from the electronic device with image capture capabilities;
determining a current time using image analysis operations on the image of the time keeping device; and
setting the current time on a clock associated with the electronic device with image capture capabilities.

2. The method of claim 1 wherein the time keeping device is selected from a set of time keeping devices including: a wall clock, a wristwatch and a drawing of a clock.

3. The method of claim 2 wherein the time keeping device displays time in a format selected from a set of formats including: an analog clock format, a digital clock format and a combination of analog and digital clock formats.

4. The method of claim 1 wherein the image capture capabilities are derived from a camera integrated into the electronic device.

5. The method of claim I wherein the image capture capabilities are derived from a camera remotely connected to the electronic device over a network.

6. The method of claim 5 wherein the remote connection between the camera and the electronic device is selected from a set of connections including: a wired connection and a wireless connection.

7. The method of claim 1 wherein the image capture capabilities are not utilized and the image of the time keeping device is generated synthetically from existing time, day and date information.

8. The method of claim 1 wherein determining a current time using image analysis includes:
determining if the time keeping device in the image displays time using either an analog clock format or a digital clock format;
performing optical character recognition to obtain the current time through when the determination indicates the displayed time is compatible with the digital clock format; and
identifying hand and dial positions in the image to obtain the current time when the determination indicates the time is displayed using the analog clock format.

9. The method of claim 8 wherein performing optical character recognition to obtain the current time further includes:
dividing a digital clock portion of the image into numeric segment values;
selecting a font corresponding to the numeric segment values;
comparing each of the numeric segment values with a filter corresponding to the potentially different numeric segment values; and
interpreting the numeric segment values to determine the current time in response to the comparison.

10. The method of claim 9 wherein the font is selected from a ranked sequence of fonts typically used to display time in time keeping devices.

11. The method of claim 9 wherein the dividing further includes selecting one or more timing indicators selected from a set including: a time-of-day indicator specifying either “AM” or “PM” time of day, a month indicator specifying the current month, a date indicator specifying the current date and a year indicator specifying a current year.

12. The method of claim 9 wherein identifying hand and dial positions in the image to obtain the current time further includes:
identifying a relative position of hands in the image to each other;
determining an orientation of a dial on the time keeping device;
correlating the relative position of hands to the orientation of the dial on the time keeping device;
obtaining the current time based upon the position of the hands and the orientation of the dial on the time keeping device.

13. The method of claim 12 wherein correlating the relative position of hands to the orientation of the dial uses a lookup table with angles of the hands and positions relative to the dial on the time keeping device.

14. An apparatus for synchronizing a clock in an electronic device having image capture capabilities, comprising:
a processor capable of executing instructions;
a memory containing instructions when executed cause the processor to receive an image of a time keeping device from the electronic device with image capture capabilities, determine a current time using image analysis operations on the image of the time keeping device and set the current time on a clock associated with the electronic device with image capture capabilities.

15. The apparatus of claim 14 wherein the time keeping device is selected from a set of time keeping devices including: a wall clock and a wristwatch.

16. The apparatus of claim 15 wherein the time keeping device displays time in a format selected from a set of formats including: an analog clock format, a digital clock format and a combination of analog and digital clock formats.

17. The apparatus of claim 14 wherein the image capture capabilities are derived from a camera integrated into the electronic device.

18. The apparatus of claim 14 wherein the image capture capabilities are derived from a camera remotely connected to the electronic device over a network.

19. The apparatus of claim 18 wherein the remote connection between the camera and the electronic device is selected from a set of connections including: a wired connection and a wireless connection.

20. The apparatus of claim 14 wherein the image capture capabilities are not utilized and the image of the time keeping device is generated synthetically from existing time, day and date information.

21. The apparatus of claim 14 wherein instructions that determine a current time using image analysis further includes instructions that,
determine if the time keeping device in the image displays time using either an analog clock format or a digital clock format, perform optical character recognition to obtain the current time through when the determination indicates the displayed time is compatible with the digital clock format and identify hand and dial positions in the image to obtain the current time when the determination indicates the time is displayed using the analog clock format.

22. The apparatus of claim 21 wherein the instructions that perform optical character recognition to obtain the current time further includes instructions that,
divide a digital clock portion of the image into numeric segment values, select a font, corresponding to the numeric segment values, compare each of the numeric segment values with a filter corresponding to the potentially different numeric segment values and interpret the numeric segment values to determine the current time in response to the compare.

23. The apparatus of claim 22 wherein the font is selected from a ranked sequence of fonts typically used to display time in time keeping devices.

24. The apparatus of claim 22 wherein the instructions that divide further include instructions to select one or more timing indicators from a set including: a time-of-day indicator specifying either “AM” or “PM” time of day, a month indicator specifying the current month, a date indicator specifying the current date and a year indicator specifying a current year..

25. The apparatus of claim 22 wherein the instructions that identify the hand and dial positions in the image to obtain the current time further includes instructions that, identify a relative position of hands in the image to each other, determine an orientation of a dial on the time keeping device, correlate the relative position of hands to the orientation of the dial on the time keeping device, obtain the current time based upon the position of the hands and the orientation of the dial on the time keeping device.

26. The apparatus of claim 25 wherein the instructions that correlate the relative position of hands to the orientation of the dial use a lookup table with angles of the hands and positions relative to the dial on the time keeping device.

27. An apparatus for synchronizing a clock in an electronic device having image capture capabilities, comprising:
means for receiving an image of a time keeping device from the electronic device with image capture capabilities;
means for determining a current time using image analysis operations on the image of the time keeping device; and
means for setting the current time on a clock associated with the electronic device with image capture capabilities.

28. The method of claim 1 wherein the current time is set at a later point in time using a time stamp associated with the image of the time keeping device.

29. The apparatus of claim 14 wherein the current time is set at a later point in time using a time stamp associated with the image of the time keeping device
